(19) United States
(12) Patent Application Publication
(10) Pub. No.: US 2025/0306621 A1
(43) Pub. Date: Oct. 2, 2025

(54) Switching Of Regulator Drive Strength

(71) Applicant: TEXAS INSTRUMENTS INCORPORATED, Dallas, TX (US)

(72) Inventors: Bhargov Bora, Bangalore (IN); Michael Zwerg, Dallas, TX (US); Nimish Sehgal, Bangalore (IN); Jinal Shah, Bangalore (IN)

(21) Appl. No.: 18/924,972

(22) Filed: Oct. 23, 2024

Related U.S. Application Data
(60) Provisional application No. 63/569,845, filed on Mar. 26, 2024.

(51) Int. Cl. G05F 1/59

(52) U.S. Cl. CPC G05F 1/59

(57) ABSTRACT

A system includes a battery powered domain, which may be powered by a voltage regulator, such as a low dropout (LDO) regulator. The components of the system may, as a default, maintain a lower-power state to preserve battery charge but may periodically go to a higher-power state to facilitate memory reads and writes and interrupts. The system may include hardware to change a power state of the regulator based on control signals that are also used for clock gating, thereby achieving quick transitions between the power states.

### CROSS-REFERENCE TO RELATED APPLICATIONS

The present application claims the benefit of U.S. Provisional Patent Application 63/569,845, filed Mar. 26, 2024, the disclosure of which is hereby incorporated by reference in its entirety.

### TECHNICAL FIELD

The present application relates to circuits, generally, and more specifically to circuits that may switch a drive strength of a regulator.

### BACKGROUND

Power supplies for a circuit may come in different forms. One example power supply may include a regulator, such as a voltage regulator or current regulator. Some regulators may be designed for near constant use, whereas other regulators may be designed for occasional or periodic higher output.

### SUMMARY

In accordance to an embodiment, a method includes: transmitting a control signal to a first clock gating circuit; and changing a bias current of a regulator based on the control signal.

In accordance to an embodiment, a circuit includes: a clock gate controlling circuit; a first clock gate coupled to the clock gate controlling circuit; a regulator; and a regulator controlling circuit coupled to the regulator and to the clock gate controlling circuit, where the clock gate controlling circuit is configured to transmit a control signal to the first clock gate and to cause the regulator controlling circuit to change a bandwidth of the regulator in response to the control signal.

In accordance to an embodiment, a circuit includes: a clock gate controlling circuit; a clock gate coupled to the clock gate controlling circuit; a regulator coupled to a first supply and a second supply, the regulator including a first transistor configured to carry current on a path between the first supply terminal and the second supply terminal; and a regulator controlling circuit coupled to the regulator and to the clock gate controlling circuit, where: the clock gate controlling circuit is configured to transmit a control signal to the clock gate; and the clock gate controlling circuit is coupled to a first input of the regulator, where the clock gate controlling circuit is configured to apply a voltage to the first input of the regulator to change the current based on the control signal.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example system, according to some embodiments

FIG. 2 is an illustration of an example power distribution architecture, which may be implemented within the example system of FIG. 1, according to some embodiments;

FIG. 3 is an illustration of an example clock tree, which may be implemented in a system, such as the example system of FIG. 1, according to some embodiments;

FIG. 4 is an illustration of an example low dropout (LDO) voltage regulator, according to some embodiments;

FIGS. 5 and 6 illustrate example controllable components, which may be implemented as the example controllable component of FIG. 4, according to some embodiments; and

FIG. 7 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

An example coin-cell battery powered system-on-a-chip (SoC) may need to run for an extended period of time (e.g., 10 years) without any interruption for certain functions, e.g., a real-time clock. Hence, this may call for the average current consumption for the function to be less than 1.5 uA, so that a coin cell battery like CR2032 runs for about 10 years of lifetime. This puts a strict constraint on the area of a low dropout voltage regulator (LDO) design to be ultra-lower-power to meet the average current goal while providing a high peak current for a short time when the SoC requires.

Meeting both the goals of ultra-low average current and momentarily high peak current together for a capless LDO (a regulator without an external capacitor) is a challenge. Safety-aware applications may have any number of system requirements to ensure that the device they are running on is operating within the parameters it is defined for. These requirements may include monitoring the external environment (e.g., voltage, temperature), monitoring operation using dedicated hardware circuits (e.g., brownout circuit, clock fault detect, parity or error correction code), and/or using software algorithms to detect whether the device function is normal.

Various embodiments provide circuits and methods for changing a drive strength of a regulator. For instance, a regulator may include a low dropout (LDO) voltage regulator, and circuits and methods may dynamically change a bias current of the LDO, change a bandwidth of the LDO, and/or change an amount of current through a pass transistor of the LDO.

In one example, a system includes a component in a battery-powered domain and a processor core in a supply-powered domain. For instance, the component may include a real-time clock circuit with an interrupt module. The real-time clock circuit may, during the normal course of operation, maintain a counter according to a low-frequency oscillator and under power of an LDO. The processor core may be powered by another supply (e.g., VDD) and communicate with the real-time clock circuit for short periods of time and, when doing so, at least portions of the real-time clock circuit may be synchronized by a high-frequency oscillator. In one example, the high-frequency oscillator provides a system clock, which also synchronizes operations of the processor core.

Continuing with the example, the real-time clock circuit may be configured to trigger the processor core to read and/or write to registers within the real-time clock circuit during an interrupt operation. For instance, the real-time clock circuit may include logic configured to request the system clock from an aggregator circuit. In response to the request, the aggregator circuit may un-gate the system clock, thereby allowing the system clock to synchronize the functions of at least part of the real-time clock circuit. The aggregator circuit may un-gate the system clock by transmitting a control signal to a clock gating circuit. The real-time clock circuit may then send an interrupt signal to the processor core, and the processor core may then read and/or write to interrupt registers of the real-time clock circuit. Once the interrupt operation is over, the real-time clock circuit may disable the request to the aggregator, thereby causing the clock gating circuit to gate the system clock.

The example actions described above allow for the real-time clock circuit to receive a system clock when appropriate and to otherwise operate under control of a low-frequency oscillator. Further in this example, the real-time clock circuit runs on battery power via the LDO. During normal operation with the low-frequency oscillator, the LDO may provide a small amount of power to the real-time clock circuit, but that power may be increased when portions of the real-time clock circuit are under control of the system clock. Various embodiments may configure the aggregator logic to change the behavior of the LDO based on a control signal sent by the aggregator to the clock gating circuit. For instance, the aggregator circuit may provide a signal to an LDO control circuit, and the LDO control circuit may then change the behavior of the LDO to attain a higher-power state. When the request from the real-time clock circuit is disabled, the aggregator circuit may discontinue the signal to the LDO control circuit, thereby causing the LDO control circuit to revert the behavior of the LDO to a lower-power state.

The example described above refers to a real-time clock circuit, though the scope of implementations may include gating and un-gating a system clock to other components and using clock gating control signals to cause a power state change in a regulator. For instance, another component may include a memory, which may be configured to receive a gated system clock. The scope of implementations may include gating and un-gating a system clock to any appropriate component and using clock gating signals to cause a power state change in a regulator.

Various embodiments may use hardware logic to change behavior of a regulator (e.g., an LDO) based on a clock gating control signal. In some implementations, the aggregator circuit may be configured to cause the regulator to go from a lower-power state to a higher-power state in a same clock cycle as the clock gating control signal. The aggregator circuit may then maintain the regulator in the higher-power state for as long as is appropriate and then cause the regulator to revert to the lower-power state, e.g., based on the clock gating control signal. In some implementations, causing the regulator to revert to the lower-power state may be performed within a same clock cycle as a change in the clock gating control signal.

Various implementations may include advantages over other solutions. For instance, the embodiments described above may cause a power state change based on a clock gating control signal, which is a hardware signal. The functionality of the aggregator circuit may be based on hardware logic as well, thereby advantageously providing relatively fast operation, such as one or two clock cycles to change a power state of a regulator. As a result, the amount of time during which the regulator is in a higher-power state, and/or the latency of state transitions of the regulator, may be reduced or minimized. By contrast, using software functionality to change the power state of the regulator may result in a substantial quantity of clock signals to switch from the lower-power state to the higher-power state and/or another substantial quantity of clock signals to revert back to the lower-power state, which may result in higher power consumption and/or latency.

Various regulators may be subject to a trade-off between ability to support a higher-power state and efficiency in a lower-power state. For instance, some regulators may be designed to support a longer higher-power state, but those designs may be less efficient during the lower-power state. By contrast, some regulators may be designed to be more efficient during the lower-power state but may only be able to support relatively short durations in the higher-power state. Thus, various embodiments that operate to shorten the duration of the higher-power state of the regulator may take advantage of more efficient regulator architectures. As a result, such systems may use less power overall.

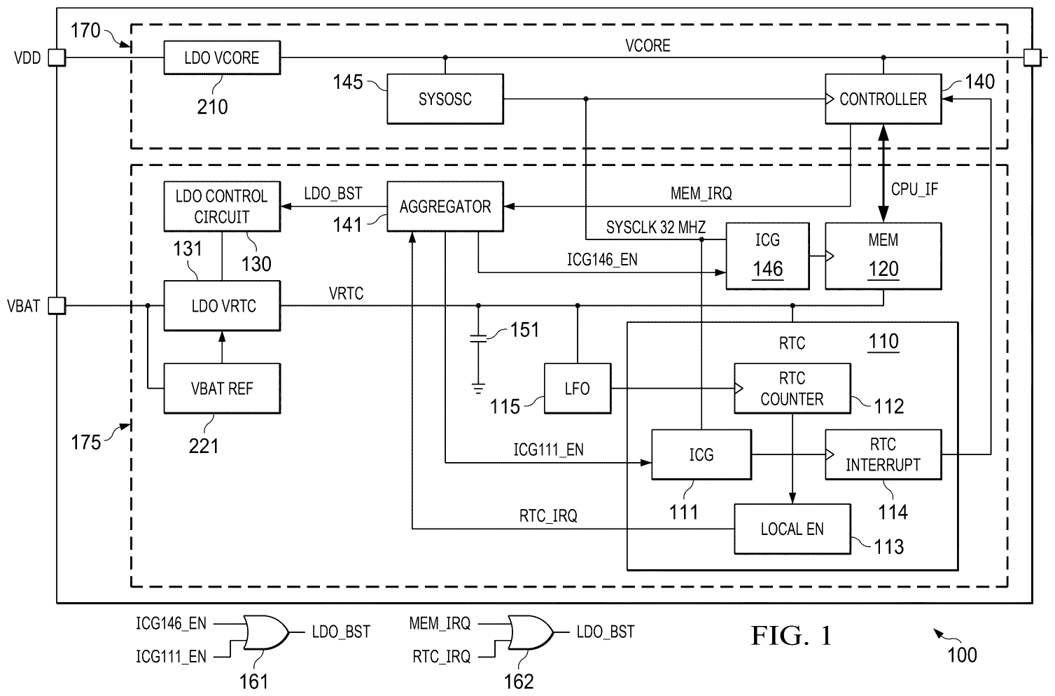

FIG. 1 is an illustration of example system 100, according to some embodiments. System 100 includes a battery powered domain 175 and a supply powered domain 170. In some instances, the battery powered domain 175 may be implemented on one or more semiconductor dies, and the supply powered domain 170 may be implemented on one or more semiconductor dies that may be the same or different from those on which the battery powered domain 175 is implemented. Of course, the scope of implementations may include any appropriate physical structure for system 100, including components mounted on one or more circuit boards or the like.

In some embodiments, system 100 may be implemented as an integrated circuit (IC), e.g., having a monolithic substrate.

Supply powered domain 170 includes a first regulator, shown as low dropout (LDO) regulator 210. LDO 210 receives power from the VDD terminal, converts that power, and supplies that power as a voltage VCORE to the other components of the supply powered domain 170. The system oscillator 145 may include any appropriate oscillating component. Controller 140 may include any appropriate processing core, such as a general-purpose processing core, a special-purpose processing core, and/or the like, and/or may be implemented or include a state machine, for example. Both the system oscillator 145 and the controller 140 are powered by the LDO 210.

In one example, the system oscillator 145 may provide a system clock for synchronizing the logic operations of the controller 140. The system oscillator 145 may be configured for any appropriate frequency or set of frequencies. In this example, the system oscillator 145 is illustrated as generating a system clock (SYSCLK) at 32 MHz. Some embodiments may use frequencies higher than 32 MHz, such as in the hundreds of MHz, or more, or lower than 32 MHz, such as in the 1 MHz or less.

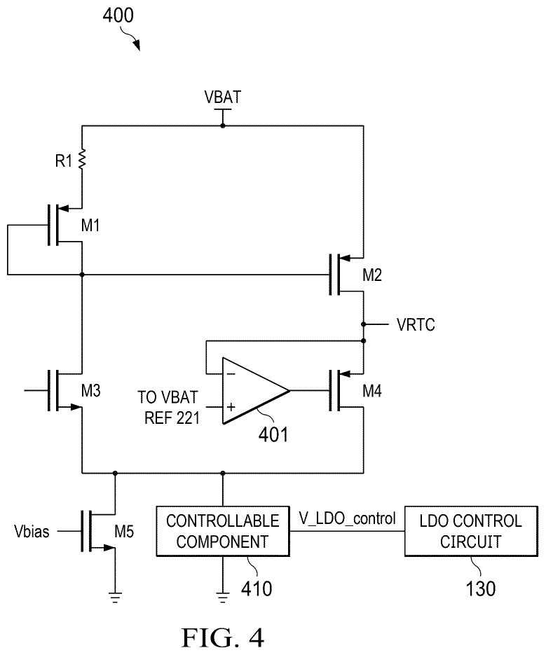

The battery powered domain 175 includes another regulator, shown as LDO 131. LDO 131 receives power from a battery (not shown) coupled to the VBAT terminal. The other components of the battery powered domain 175 receive their power from LDO 131. An example architecture for LDO 131 is shown in FIG. 4, though the scope of embodiments may include any appropriate LDO architecture.

In some embodiments, the VBAT terminal is designed to be connected to a battery, such as a coin cell battery. Some embodiments may be designed other types of batteries, instead or in addition to the coin cell battery, to be connected to the VBAT terminal, such as AA or AAA batteries, Li-Ion-based batteries, etc.

In some implementations, LDO 131 may be configured for lower-power operation with only occasional higher-power operation. Put another way, LDO 131 may be configured for operation in at least two power states—a lower power state and a higher power state, where the lower power state is used normally, and the higher power state may be used occasionally (e.g., once per second, once per minute, once per day). Examples of lower-power states and higher-power states are described in more detail below.

Real-time clock (RTC) circuit 110 is powered by the LDO 131 and is configured to receive a clocking signal from the low-frequency oscillator (LFO) 115 and a clocking signal from the system oscillator 145 via the clock gating circuit 111. In one example, the LFO 115 is powered by the LDO 131 and is configured to provide a clock signal for the RTC counter 112. In some implementations, the LFO 115 may provide a clock signal that is one or more orders of magnitude slower than the system clock from the system oscillator 145. For instance, in one example, the LFO 115 may provide a clock signal of 32 kHz, though the scope of implementations may include any appropriate clocking signal, such as a signal with frequencies higher than 32 kHz, such as in the hundreds of kHz or more, or less than 32 kHz, such as 8 kHz, 1 kHz, or less. Furthermore, LFO 115 may include or be connected to any appropriate oscillating component, such as an internal local oscillator and/or an external crystal.

The RTC counter 112 may be configured to provide real-time clock functionality by either incrementing or decrementing a value stored in the RTC counter 112 per clock cycle of the LFO 115. In fact, system 100 may be configured so that the RTC 110 continues to increment or decrement the counter 112 as long as there is sufficient power from the VBAT terminal, and even if the VDD power supply is interrupted or inactive. Thus. The RTC 110 may continue to maintain its count, whether the VDD power supply is active or inactive.

Local enable logic 113 may track the value in RTC counter 112 and may be configured to request the system clock to be provided to the RTC interrupt module 114 via the clock gating circuit 111. For instance, the local enable logic 113 may be configured so that periodically (e.g., every second or every minute) it requests the system clock from the system oscillator 145 by asserting request signal RTC_IRQ. In response, the aggregator 141 may generate enable signal ICG111_EN, which causes clock gating circuit 111 to un-gate the system clock, thereby allowing the system clock to synchronize the operations of the RTC interrupt module 114. The interrupt module 114 may then send an interrupt signal to the controller 140, thereby causing the controller 140 to perform a read or write operation directed at one or more registers of the RTC interrupt module 114. The local enable logic 113 may further be configured to de-assert the request signal RTC_IRQ once the interrupt operation is complete. The aggregator circuit 141 may, in response to the RTC_IRQ signal being de-asserted, de-assert the ICG111_EN signal, thereby causing clock gating circuit 111 to gate (or block) the system oscillator clock signal from the RTC interrupt module 114.

The example system 100 further includes, within battery powered domain 175, a (e.g., non-volatile) memory 120. In this example, the memory 120 may include an appropriate quantity of memory cells to store desired data and have that data be persistent as long as the power from the VBAT terminal continues. Normally, the memory 120 may be un-clocked until the controller 140 is ready to perform a read or a write operation with respect to memory cells of memory 120. Thus, the memory 120 in this example may omit consuming any clock signal unless it is actively being written to or read from by the controller 140.

In an example read or write operation, the controller 140 may request that the system clock signal from the system oscillator 145 be provided to the memory 120 through the clock gating circuit 146. The controller 140 may make such a request by asserting request signal MEM_IRQ, which is received by the aggregator 141. In response to the request signal MEM_IRQ being asserted, the aggregator 141 may then assert the enable signal ICG146_EN, which causes the clock gating circuit 146 to un-gate the system clock signal, thereby providing the system clock signal from the system oscillator 145 to memory 120. The controller 140 may then perform appropriate read operations and/or write operations. Once the controller has completed its read operations and/or write operations, then the controller 140 may de-assert the request signal MEM_IRQ, which may cause the aggregator 141 to then de-assert the enable signal ICG146_EN. When the enable signal ICG146_EN is de-asserted, then the clock gating circuit 146 gates the system clock from the system oscillator 145, thereby isolating memory 120 from the system oscillator 145.

The system 100 may be configured for use in any appropriate application. One example application may include a utility meter, such as for electricity. The local enable logic 113 may be configured to cause interrupts from the RTC 110 to the controller 140. In response to an interrupt, the RTC 110 may read a timestamp, based on the RTC counter 112, from the RTC interrupt logic 114 and then store that timestamp and a measurement (e.g., sensor data) to the memory 120. For instance, the measurement may be for electricity use, so that the local enable logic 113 and the controller 140 may be configured to store a multitude of time stamped electricity meter readings to the memory 120. The time stamped meter readings may be read from the memory 120 at any appropriate time for purposes of auditing, billing, or the like. Some embodiments may include reading the data (e.g., sensor data) from the memory periodically (e.g., every second, every minute, every day) by periodically asserting the request signal MEM_IRQ during a time when supply powered domain 170 is powered on. However, when the supply powered domain 170 is not powered on (e.g., VDD supply is inactive), controller 140 may not assert the request signal MEM_IRQ.

As noted above, an interrupt operation and a memory read or write operation may be facilitated by applying (e.g., by un-gating the clock SYSCLK using 111 and 146, respectively) the system clock signal from the system oscillator 145 to the RTC 110 and the memory 120. Once the interrupt operation and the memory read or write operation are completed, then the clock signal from the system oscillator 145 may be gated (blocked) from the memory 120 and the RTC 110 (e.g. using 111 and 146).

VBAT reference 221 receives a voltage from the VBAT terminal and generates a reference voltage for use by the LDO 131. In one example, VBAT reference 221 may include a bandgap voltage generator, though the scope of implementations may include any appropriate reference voltage generator. Decoupling capacitor 151 may be built into the semiconductor material of a die on which the battery powered domain 175 is built. In an example in which the battery powered domain 175 is not built upon a semiconductor die, decoupling capacitor 151 may be implemented in any appropriate manner.

As noted above, the LDO 131 may be configured to operate in a lower-power state and in a higher-power state. The LDO control circuit 130 is configured to control the power state operation of the LDO 131 in response to a control signal LDO_BST, received from aggregator 141. In one example, when aggregator 141 asserts control signal LDO_BST, that may cause LDO control circuit 130 to put LDO 131 into the higher-power state, and when aggregator 141 de-asserts the control signal LDO_BST, that may cause the LDO control circuit 130 to put LDO 131 into the lower-power state.

The aggregator 141 acts as a clock gate controlling circuit in this example by receiving request signal RTC_IRQ and, in response thereto, asserting enable signal ICG111_EN. Similarly, when aggregator 114 detects that the request signal RTC_IRQ is de-asserted, then aggregator 114 may de-assert enable signal ICG111_EN. Additionally, aggregator 141 may receive request signal MEM_IRQ and, in response, assert enable signal ICG146_EN; aggregator 141 may also be configured to de-assert enable signal ICG146_EN when it detects that request signal MEM_IRQ is de-asserted.

Aggregator 141 may be configured so that it asserts and de-asserts the control signal LDO_BST based on control (enable) signals ICG111_EN and ICG146_EN. For instance, aggregator 141 may include a Boolean logic gate or an array of Boolean logic gates to provide such functionality. In one implementation, aggregator 141 may include OR gate functionality, such as illustrated by OR gate 161. In such an implementation, as long as either one or both of the signals ICG111_EN and ICG146_EN is asserted, then LDO_BST is asserted as well. If both signals ICG111_EN and ICG146_EN are de-asserted, then LDO_BST is de-asserted as well. In other words, in a scenario in which aggregator 141 asserts either or both of ICG111_EN and ICG146_EN, then aggregator 141 may also assert LDO_BST, thereby causing LDO 131 to transition from a lower-power state to a higher-power state. In a scenario in which aggregator 141 is not currently asserting either or both of ICG111_EN and ICG146_EN, then aggregator 141 would de-assert LDO_BST, thereby maintaining LDO 131 in the lower-power state.

Additionally or alternatively, aggregator 141 may be configured so that it asserts and de-asserts the control signal LDO_BST based on the request signals MEM_IRQ and RTC_IRQ. Such functionality is illustrated by OR gate 162 (which may be implemented as part of aggregator 141). If either or both of the signals MEM_IRQ and RTC_IRQ are asserted, then LDO_BST is also asserted; if both the signals MEM_IRQ and RTC_IRQ are de-asserted, then LDO_BST is also de-asserted.

The embodiment shown in FIG. 1 may include various advantages. For instance, the functionality provided by OR gate 161 may be used to cause the LDO 131 to transition from the lower-power state to the higher-power state at approximately a same time as a clock edge from the system clock is received at the RTC 110 or the memory 120 via respective clock gating circuits 111 and 146. In fact, the LDO 131 may be caused to transition from the lower-power state to the higher-power state even before a clock edge from the system clock is received by the RTC 110 or the memory 120. Similarly, the system clock may be re-gated relatively quickly, even within a same clock cycle of the system clock, by the OR gate 161 de-asserting the LDO_BST signal.

Furthermore, in a scenario in which the functionality provided by the OR gate 162 is used, the aggregator 141 may cause the LDO 131 to transition from the lower-power state to the higher-power state at the same time as (or even before) the aggregator 141 asserts either of the signals ICG146_EN or IGC 111_EN. Some implementations may even cause the LDO 131 to transition from the lower-power state to the higher-power state one or more cycles of the system clock before the system clock is un-gated by either of the clock gating circuits 111, 146.

Such embodiments may provide a quick transition from one power state to another, thereby shortening an amount of time during which the LDO 131 operates in the higher-power state. For instance, such embodiments may facilitate higher-power states lasting as few as three or five cycles of the system clock, though the scope of implementations may include any appropriate duration of the higher-power state. As a result, the LDO 131 may be configured to prioritize the lower-power state over the higher-power state, thereby saving power usage during normal operation.

In some embodiments, such as illustrated in FIG. 1, aggregator 141 receives, e.g., interrupt signals (e.g., MEM_IRQ and/or RTC_IRQ), and the aggregator controls gating circuits (e.g., 111 and 146), e.g., based on such signals. In some embodiments, the interrupt signals may be directly provided to the gating circuits, and the aggregator signal may just control the LDO control circuit 130 (e.g., based on the interrupt signals). Other implementations are also possible.

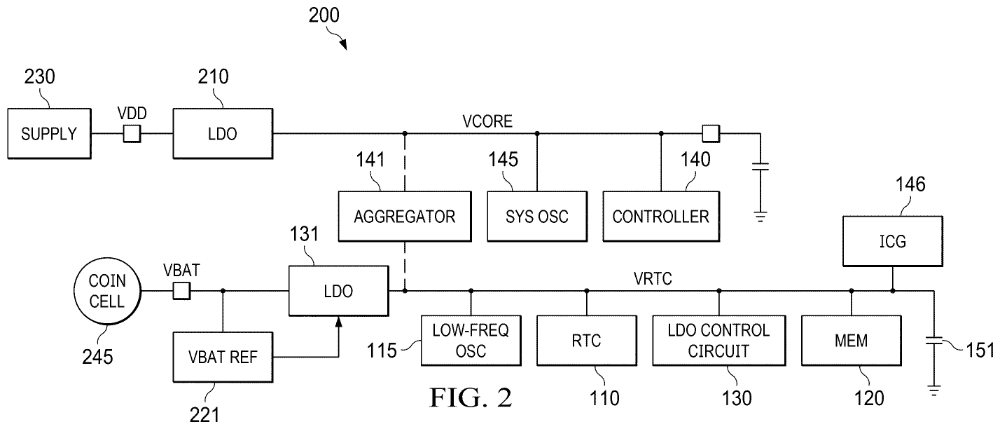

FIG. 2 is an illustration of an example power distribution architecture 200, which may be implemented within system 100 of FIG. 1, according to some embodiments. Supply 230 is coupled to the VDD terminal. The supply 230 may include any appropriate supply, such as a DC supply, which may be derived from an AC supply or from a battery (not shown), for example. LDO 210 is coupled to the VDD terminal and produces a voltage VCORE for use by system oscillator 145 and controller 140. The voltage VCORE is referenced to ground in this example.

Coin cell 245 is coupled to the VBAT terminal. The coin cell 245 may produce a DC voltage. The DC voltage from the coin cell 245 is received by VBAT reference 221 and LDO 131. VBAT reference 221 may produce a reference voltage based on the coin cell voltage, and that reference voltage may be used by LDO 131. LDO 131 converts the coin cell voltage to another regulated voltage VRTC. The regulated voltage VRTC is used by low-frequency oscillator 115, the components within RTC 110, memory 120, LDO control circuit 130, and ICG146. Decoupling capacitor 151 is coupled between VRTC and ground. The scope of implementations may use any appropriate power source at the VBAT terminal, such as a cell that is not coin-shaped, a capacitor, or the like.

Aggregator 141 may be configured to be powered either by the voltage VCORE or VRTC. In other words, the dotted line of FIG. 2 illustrates two different alternatives for powering aggregator 141. Thus, even though FIG. 1 shows aggregator 141 as being implemented within the battery powered domain 175, various embodiments may instead power aggregator 141 from another supply, such as VDD.

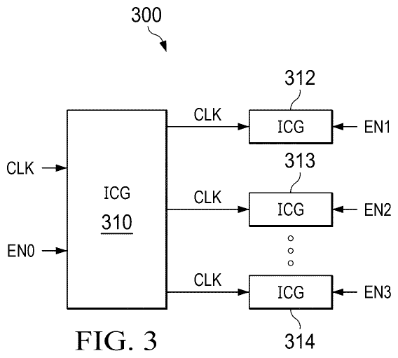

FIG. 3 is an illustration of an example clock tree 300, which may be implemented in a system, such as system 100, according to some embodiments. In FIG. 1, there is a single level of clock gating, as illustrated by clock gating circuits 111 and 146. However, other implementations may use multiple levels of clock gating, as illustrated by clock tree 300. The clock signal CLK may be representative of another clock, such as the system clock associated with the system oscillator 145 of FIG. 1. ICG 310 is a first-level clock gating circuit in this example, and it may be enabled by enable signal EN0. For instance, when EN0 is asserted, clock gating circuit 310 may allow the signal CLK to pass to the second level clock gating circuits 312-314; when EN0 is de-asserted, clock gating circuit 310 may isolate clock gating circuits 312-314 from the signal CLK.

The second level clock gating circuits 312-314 may include any appropriate number of clock gating circuits, as indicated by the ellipses. Each of the second level clock gating circuits 312-314 receives a respective enable signal EN1-EN3. In some instances, each of the second level clock gating circuits 312-314 may be coupled to synchronous circuits (e.g., such as may be included in memory 120 and/or RTC interrupt module 114). In other instances, the second level clock gating circuits 312-314 may be coupled to third level clock gating circuits (not shown). In other words, clock tree 300 may have any appropriate quantity of levels in various embodiments.

In one example, an aggregator, such as aggregator 141 of FIG. 1, may be configured to assert and de-assert the enable signals EN0-EN3 in response to request signals (e.g., MEM_IRQ, RTC_IRQ). Furthermore, although not shown explicitly in FIG. 3, any one or more of the enable signals EN0-EN3 may be used to cause a change in operation of a regulator. For example, an aggregator, such as aggregator 141, may be configured with hardware logic to either assert or de-assert a signal (e.g., LDO_BST) in response to states of the enable signals EN0-EN3. One example may include a three-input (or greater quantity of inputs) OR gate configured to receive the enable signals EN0-EN3 and to output LDO_BST, though the scope of implementations may include any appropriate hardware logic to assert and de-assert LDO_BST or other control signal.

The enable signals EN0-EN3 may be generated independently to control the different clock gating circuits 310 and 312-314 independently. On the other hand, the enable signals EN0-EN3 may be the same signal in some implementations. Additionally, some implementations may synchronize various signals so that the EN0 signal causes a change at clock gating circuit 310 that is simultaneous with a change at any of clock gating circuits 312-314 caused by any of the respective enable signals EN1-EN3.

Furthermore, clock gating circuits, such as 111, 146, 310, and 312-314 may be configured to output a same clock signal as received. In other words, the clock gating circuits may be configured so that the clock signal output has a same frequency and phase as the system clock. However, various implementations may include other types of clock gating hardware, which may alter a frequency and/or a phase of a clock so that the output clock signal is not necessarily the same clock signal as the input clock signal.

FIG. 4 is an illustration of an example LDO 400, according to some embodiments. For instance, example LDO 400 may be implemented as LDO 130 of FIG. 1, though LDO 130 of FIG. 1 may be implemented using any appropriate architecture.

LDO 400 is coupled between the power supply voltage (the voltage at terminal VBAT, e.g., from the coin cell battery 245) and ground. There are two current paths. In a first current path, resistor R1 is coupled in series with p-type metal oxide semiconductor (PMOS) device M1, n-type metal oxide semiconductor (NMOS) device M3, and NMOS device M5. In a second current path, PMOS device M2 is coupled in series with PMOS device M4 and NMOS device M5.

Device M1 has a gate that is coupled to the drain of M1. The gate of M2 is also coupled to the drain of M1. The gate of M4 is coupled to the output of operational amplifier 401. The inverting input of the operational amplifier 401 is coupled to the source of M4, and the non-inverting input of the operational amplifier 401 is coupled to the output of VBAT reference 221. The output of VBAT reference 221 is a reference voltage and, thus, the arrangement of operational amplifier 401 and transistor M4 operates to keep the gate voltage of transistor M4 at approximately the same voltage as the source of transistor M4. Transistor M3 may be configured as an always-on transistor, so its gate may be coupled to a constant or nearly constant voltage, thereby keeping transistor M3 in an ON state. Furthermore, bias transistor M5 may be controlled by the voltage Vbias. The voltage Vbias may be provided by any appropriate component, such as aggregator 141 or other circuit. Generally, as Vbias increases, transistor M5 allows more current to pass to ground, and as Vbias decreases, transistor M5 allows less current to pass to ground.

Transistor M2 may be referred to as a pass transistor, and the voltage VRTC may be taken at the drain of transistor M2, which is also the source of transistor M4. During normal use, is expected that VRTC be kept relatively stable to provide dependable power to the components of the battery powered domain 175. Should the voltage at the VBAT terminal fluctuate, the architecture of LDO 400 is expected to maintain the level of the RTC.

LDO 400 also includes controllable component 410, which is coupled to an output of the LDO control circuit 130. In one example, the LDO control circuit 130 includes values in a register (not shown), where those values determine a voltage level of V_LDO_control. Furthermore, in this example, the values stored in LDO control circuit 130 may be affected by the signal LDO_BST. For instance, when aggregator 141 asserts the signal LDO_BST, that may change the values stored in LDO control circuit 130, thereby causing a level of V_LDO_control to change either up or down. As a result, the controllable component 410 may either increase or decrease an amount of current through the first and second current paths. In some embodiments, the controllable component 410 may be controllable as to the amount of bias current it passes to ground, and the controllable component 410 may be arranged in parallel with the bias transistor M5.

The controllable component 410 may be employed to change a power state of the LDO 400. Specifically, when the controllable component 410 is either OFF or conducts a relatively small amount of bias current to ground, that may correspond to the lower-power state of LDO 400. When the controllable component 410 is either ON or conducts a relatively large amount of bias current to ground, that may correspond to the higher-power state of LDO 400.

In one example use case, the aggregator 141 may assert the LDO_BST signal to cause the LDO 400 to transition from the lower-power state to the higher-power state. In response, the LDO control circuit 130 may change a voltage level of the signal V_LDO_control to cause the controllable component 410 to conduct more bias current to ground. The aggregator 141 may then de-assert the LDO_BST signal to cause the LDO 400 to transition from the higher-power state back to the lower-power state. Specifically, the LDO control circuit 130 may, in response to LDO_BST signal being de-asserted, change the voltage level of the signal V_LDO_control to cause the controllable component 410 to conduct less bias current to ground.

When the controllable component 410 transitions from conducting less bias current to conducting more bias current, that may increase the amount of current through transistor M2 and also at least temporarily increase a bandwidth of the LDO 400. LDO 400 may be configured to operate effectively, including responding to changes in load or input voltage, across a frequency range. This frequency range may be increased in LDO 400 by increasing the amount of current through transistor M2. As the controllable component 410 transitions from conducting more bias current to conducting less bias current, that may decrease the amount of current through transistor M2 and also reduce the bandwidth of the LDO 400.

Additionally, in some implementations, the decoupling capacitor 150 of FIG. 1 may be sized so that it stores enough charge to momentarily increase an amount of current through transistor M2 and the controllable component 410 during a power state change from lower-power to higher-power.

It is noted that the controllable component 410 and the LDO control circuit 130 may be implemented in any appropriate manner. For instance, as noted above, LDO control circuit 130 may be implemented to include one or more registers to store values that affect a voltage level of V_LDO_control. For instance, the one or more registers may store default values that may be used during the lower-power state and may also store further values that may be used during the higher-power state (e.g., where the value of signal LDO_BST selects which of the registers is used to control the voltage level of V_LDO_control). In some embodiments, the aggregator 141 transmitting an enable signal to the clock gating circuits and the aggregator 141 changing the data in the LDO control circuit 130 may be performed during a same clock cycle (e.g., and in response to a same clock edge) of the system clock. It is also within the scope of implementations that the LDO control circuit 130 may be designed as an analog circuit that does not depend upon stored values.

In some embodiments, the combined current flowing through M5 and 410 is lower in the low power state than in the high power state.

Also, while the LDO 400 is shown with a particular architecture and a particular use of PMOS devices and NMOS devices, it is understood that other architectures and other NMOS or PMOS devices may be used. Also, while the signals in the examples herein, such as MEM_IRQ, RTC_IRQ, LDO_BST, ICG111_EN, and ICG146_EN are discussed as being active-high, other implementations may use active-low signals as appropriate.

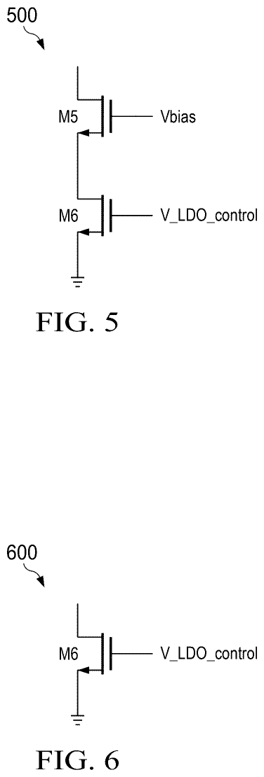

FIGS. 5 and 6 illustrate example controllable components 500 and 600, which may be implemented as controllable component 410 in the example of FIG. 4, according to some embodiments.

In the example of FIG. 5, the controllable component may be implemented in series with bias transistor M5, rather than in parallel with bias transistor M5 as shown in FIG. 4. Specifically, the example controllable component 500 is illustrated as including both transistor M5 and transistor M6 in series with ground. For instance, the example controllable component 500 may be coupled so that the drain of transistor M5 is coupled to the source of transistor M3 and the drain of transistor M4 in FIG. 4. The source of transistor M5 may be coupled to the drain of transistor M6, and the source of transistor M6 may be coupled to ground. In the embodiment of FIG. 5, the bias current through the controllable component 500 determines the lower-power state or higher-power state of the LDO 400, and the series arrangement of transistors M5 and M6 may cause the transistors M5 and M6 to be not necessarily independently controllable.

In the example of FIG. 6, the controllable component is illustrated as transistor M6, and transistor M6 may be arranged in parallel to transistor M5. Specifically, the drain of transistor M6 may be coupled to the source of transistor M3 and the drain of transistor M4 to ground, such as is illustrated in FIG. 4. Since transistors M6 and M5 are implemented in parallel in the example of FIG. 6, that may allow for transistors M5 and M6 to be controlled independently.

In the arrangement of FIG. 5 and in the arrangement of FIG. 6, the transistor M6 may act as a switch that may be controlled to be ON or OFF, with OFF corresponding to a lower-power state and ON corresponding to a higher-power state of the LDO 400. Alternatively, transistor M6 may be held in a linear region, with a higher-conducting portion of the linear region corresponding to the higher-power state, and a lower-conducting portion of the linear region corresponding to the lower-power state.

In another embodiment (now shown), transistor M6 may be implemented in series with another transistor (not shown) that is biased with a voltage, such as Vbias. In such embodiment, such series arrangement may be in parallel with transistor M5.

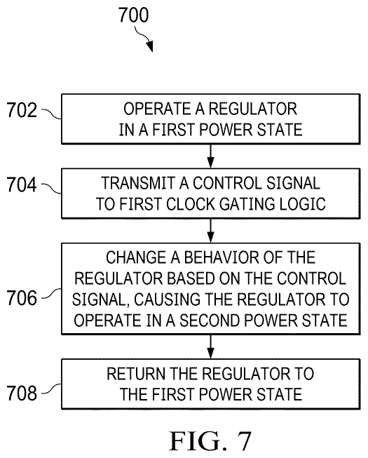

FIG. 7 is an illustration of an example method 700, according to some embodiments. The method 700 may be performed by a system, such as system 100 of FIG. 1, which includes a controllable regulator, such as LDO 130 or LDO 400.

Action 702 includes operating a regulator in a first power state. In the example of FIG. 4, the regulator includes an LDO 400 (which may be implemented as the LDO 130 in FIG. 1). The first power state may be a lower-power state, where the lower-power state may correspond to a load that is associated with a low-frequency oscillator clock signal, maintaining data in memory, and other relatively low-load tasks. The lower-power state may encompass a variety of different tasks that do not use a clock signal from a high-frequency oscillator. An example of a low-frequency oscillator clock signal may be a clock signal derived from low-frequency oscillator 115 of FIG. 1, whereas a high-frequency oscillator clock signal may correspond to the system clock (SYSCLK) derived from system oscillator 145.

Action 704 includes transmitting a control signal to a first clock gating circuit. In one example, a clock gate controlling circuit, such as aggregator 141, may transmit a control signal (e.g., an enable signal) to one or both of the clock gating circuits 111, 146. In this example, transmitting the control signal may include either asserting or de-asserting a control signal. The control signals of action 704 may be transmitted in response to a request signal.

Action 706 includes changing a behavior of the regulator based on the control signal. In one example, the control signals (e.g., enable signals) may be applied to hardware, which generates one or more signals to cause a behavior change in the regulator. For instance, in FIG. 1, the enable signals ICG146_EN and ICG111_EN may be applied to hardware logic within aggregator 141, which causes the signal LDO_BST to be asserted, which further causes a behavior change at LDO 131.

In action 706, the behavior change may correspond to the regulator transitioning from the first power state to a second power state. An example of a second power state may include a higher-power state, and the higher-power state may include a load that is associated with operation of a clock from a high-frequency oscillator. In the example of FIG. 1, the system clock is derived from the high-frequency oscillator 145, and when the system clock is applied to either or both of the memory 120 and the RTC 110, that increases the load as seen by the LDO 131. The regulator, such as LDO 131 or LDO 400, may be configured so that its ordinary operation is a lower-power state, and operation in the higher-power state may be relatively short and either frequent or infrequent.

The behavior change of action 706 may include increasing an amount of bias current, such as through controllable component 410 and/or bias transistor M5 of FIG. 4. Also, the behavior change at action 706 may include increasing an amount of current through transistor M2 and M4. Additionally, the behavior change may include increasing a bandwidth of the regulator, thereby allowing the regulator to operate more reliably within a larger frequency range, at least temporarily during the higher-power state.

In one example, actions 704-706 may correspond to a read operation or write operation of a memory (e.g., memory 120), may correspond to an interrupt operation (e.g., such as with RTC interrupt module 114), or other action that may temporarily result in a higher load on the LDO 130.

In some embodiments, the regulator transitions from the low power state to the high power state (e.g., in the same clock cycle as the un-gating operation) such that the regulator is advantageously capable of timely providing the necessary power (e.g., thus meeting load transient requirements) to operate components receiving power from the regulator (e.g., such as the memory), for performing a burst of operations (e.g., such as read or write memory operations).

Of course, such operations may be short-lived, thereby allowing the regulator to return to the first power state. Accordingly, action 708 includes returning the regulator to the first power state, which may correspond to an end of a read or write operation, an end of an interrupt operation or an end of some other action, where the end of such actions may result in the load being reduced.

Action 708 may also be based on the control signal. For instance, in the example of FIG. 1, when both of the enable signals ICG146_EN and ICG111_EN are de-asserted, the aggregator 141 may de-assert LDO_BST, thereby causing the LDO 131 to revert to the lower-power state.

In some embodiments, action 708 may be based on a predetermined time (e.g., expected duration of the burst of operations) instead of being based on the control signal.

The scope of implementations is not limited to only the series of actions 702-708 of FIG. 7. Rather, other embodiments may add, omit, rearrange, or modify various actions. In one example, one or more components may be programmed to cause a higher-power load to occur periodically or at some specified times. Therefore, the system may perform actions 702-708 repeatedly, changing from a lower-power state to a higher-power state to accommodate a higher load and then reverting to the lower-power state as a default.

Example embodiments of the present disclosure are summarized here. Other embodiments can also be understood from the entirety of the specification and the claims filed herein.

Example 1. A method including: transmitting a control signal to a first clock gating circuit; and changing a bias current of a regulator based on the control signal.

Example 2. The method of example 1, where the regulator is a direct current (DC) linear voltage regulator.

Example 3. The method of one of examples 1 or 2, where the DC linear voltage regulator is a capless low-dropout (LDO) regulator.

Example 4. The method of one of examples 1 to 3, where the first clock gating circuit provides a clock to a real-time clock (RTC) circuit, the method further including: powering the RTC circuit by the regulator.

Example 5. The method of one of examples 1 to 4, where the first clock gating circuit provides a clock to a memory, the method further including: powering the memory by the regulator.

Example 6. The method of one of examples 1 to 5, where changing the bias current of the regulator includes: changing data in a regulator control circuit to increase an amount of the bias current flowing through a first transistor.

Example 7. The method of one of examples 1 to 6, where the first transistor has a control terminal coupled to an output of an amplifier, the amplifier having a first input coupled to a first current path terminal of the first transistor.

Example 8. The method of one of examples 1 to 7, where the amplifier has a second input receiving a reference based on a first supply voltage, the method further including: generating a first clock with a first clock circuit; and providing the first clock to the first clock gating circuit; and powering the first clock circuit with a second supply voltage.

Example 9. The method of one of examples 1 to 8, where transmitting the control signal and changing the data in the regulator control circuit are performed during a same clock cycle.

Example 10. The method of one of examples 1 to 9, further including: closing a switch that is coupled to the first transistor, in response to changing the data in the regulator control circuit.

Example 11. The method of one of examples 1 to 10, further including: adjusting a voltage at a control terminal of a second transistor coupled to the first transistor in response to changing the data in the regulator control circuit.

Example 12. The method of one of examples 1 to 11, further including: receiving a first request at an aggregator circuit; transmitting the control signal from the aggregator circuit to the first clock gating circuit in response to the first request.

Example 13. The method of one of examples 1 to 12, where the first clock gating circuit provides a first clock to a first circuit, and where receiving the first request includes receiving the first request from the first circuit.

Example 14. The method of one of examples 1 to 13, further including: providing a second clock to the first clock gating circuit and to a second clock gating circuit, the second clock gating circuit providing a third clock to a memory; simultaneously un-gating the first and second clock gating circuits in response to the first request.

Example 15. The method of one of examples 1 to 14, where: the aggregator circuit is powered by a first power supply that is different from the regulator.

Example 16. The method of one of examples 1 to 15, where: the regulator control circuit is powered by the regulator.

Example 17. The method of one of examples 1 to 16, further including: disabling clock gating, by the first clock gating circuit, in response to the control signal being deasserted, where a system clock is provided to the first clock gating circuit from a supply-powered domain, where the first clock gating circuit is in a battery-powered domain, and where the regulator is in the battery-powered domain.

Example 18. The method of one of examples 1 to 17, where changing the bias current causes the regulator to change from a first power state to a second power state, the method further including:

Example 19. The method of one of examples 1 to 18, further including: transmitting a memory access request signal to access a memory circuit from a control circuit powered by a first power supply in a first power domain, where the memory circuit is powered by the regulator in a second power domain, and where transmitting the control signal includes transmitting the control signal based on the memory access request signal.

Example 20. The method of one of examples 1 to 19, further including powering the regulator with a coin cell battery.

Example 21. The method of one of examples 1 to 20, further including, in response to the memory access request signal being asserted, storing sensor data in the memory circuit.

Example 22. The method of one of examples 1 to 21, further including periodically asserting the memory access request signal when the first power supply is active.

Example 23. The method of one of examples 1 to 22, further including: powering a real-time clock (RTC) with the regulator; when the first power supply is active, maintaining a count of the RTC; and when the first power supply is inactive, maintaining the count of the RTC and preserving content of the memory circuit, where the memory access request signal is not asserted when the first power supply is inactive.

Example 24. The method of one of examples 1 to 23, where the sensor data is electricity meter sensor data.

Example 25. The method of one of examples 1 to 24, further including: providing a first clock signal to a memory circuit with a first oscillator that is powered by a first power supply in a first power domain, where the memory circuit is powered by the regulator that is in a second power domain, and where the regulator is powered by a battery.

Example 26. The method of one of examples 1 to 25, further including: powering an RTC by the regulator; and providing a second clock signal to the RTC with a second oscillator that is powered by the regulator.

Example 27. A circuit including: a clock gate controlling circuit; a first clock gate coupled to the clock gate controlling circuit; a regulator; and a regulator controlling circuit coupled to the regulator and to the clock gate controlling circuit, where the clock gate controlling circuit is configured to transmit a control signal to the first clock gate and to cause the regulator controlling circuit to change a bandwidth of the regulator in response to the control signal.

Example 28. The circuit of example 27, where the regulator includes a low dropout (LDO) voltage regulator having a pass transistor, where the regulator controlling circuit is configured to increase the bandwidth by increasing a current through the pass transistor.

Example 29. The circuit of one of examples 27 or 28, further including: an oscillator coupled to the first clock gate, where the first clock gate is configured to pass a first clock signal from the oscillator in response to the control signal.

Example 30. The circuit of one of examples 27 to 29, where the first clock gate is configured to be powered by a first power domain, and where the oscillator is configured to be powered by a second power domain.

Example 31. The circuit of one of examples 27 to 30, where the first power domain includes a battery-powered power domain configured to be powered via the regulator, and where the second power domain includes a supply powered power domain.

Example 32. The circuit of one of examples 27 to 31, further including: a capacitor coupled to the regulator, where the regulator is configured to drain charge from the capacitor in response to the bandwidth of the regulator being increased.

Example 33. The circuit of one of examples 27 to 32, where the regulator includes a low dropout (LDO) voltage regulator having a bias transistor, where the regulator control hardware logic is configured to increase the bandwidth by increasing a current through the bias transistor.

Example 34. The circuit of one of examples 27 to 33, where the regulator controlling circuit is configured to increase the current through the bias transistor by adjusting a voltage applied to a control terminal of the bias transistor.

Example 35. The circuit of one of examples 27 to 34, where the regulator controlling circuit is configured to increase the current through the bias transistor by turning on a switch in series with the bias transistor.

Example 36. The circuit of one of examples 27 to 35, where the regulator controlling circuit is further configured to revert the bandwidth of the regulator to a prior setting in response to a state of the first control signal.

Example 37. The circuit of one of examples 27 to 36, where the regulator is configured to power the clock gate controlling circuit and the first clock gate.

Example 38. The circuit of one of examples 27 to 37, where the circuit includes a meter having a real-time clock (RTC) subsystem, where the first clock gate is implemented within the RTC subsystem.

Example 39. The circuit of one of examples 27 to 38, where the circuit includes a meter having a memory, where the first clock gate is implemented within the memory subsystem.

Example 40. The circuit of one of examples 27 to 39, where the regulator is coupled to a coin cell battery and is configured to output power to the first clock gate.

Example 41. The circuit of one of examples 27 to 40, further including: a second clock gate coupled to the clock gate controlling circuit, where the clock gate controlling circuit is configured to transmit a second control signal to the second clock gate and to cause the regulator controlling circuit to change the bandwidth of the regulator in response to the second control signal.

Example 47. The circuit of one of examples 27 to 46, further including: a controller circuit coupled to the clock gate controlling circuit; and a memory coupled to the controller circuit and to the clock gate, where the controller circuit is configured to transmit a clock request signal to the clock gate controlling circuit, and where the clock gate controlling circuit is configured to generate the control signal in response to the clock request signal to cause a clock to be provided to the memory via the clock gate

Example 48. The circuit of one of examples 27 to 47, where the clock gate and the memory are configured to be powered by the regulator, and where the controller circuit is configured to be powered by a power supply separate from the regulator.

Example 49. The circuit of one of examples 27 to 48, where the regulator is configured to be powered in a battery-powered domain, and where the controller circuit is configured to be powered in another power domain.

Example 50. The circuit of one of examples 27 to 49, further including: a controller circuit coupled to the clock gate controlling circuit, where the controller circuit is configured to transmit a clock request signal to the clock gate controlling circuit, and where the clock gate controlling circuit is configured to generate the control signal in response to the clock request signal.

Example 51. The circuit of one of examples 27 to 50, where the clock gate is disposed within a real-time clock (RTC) system, where the regulator includes a power output coupled to a power input of the RTC system.

Example 42. A circuit including: a clock gate controlling circuit; a clock gate coupled to the clock gate controlling circuit; a regulator coupled to a first supply and a second supply, the regulator including a first transistor configured to carry current on a path between the first supply terminal and the second supply terminal; and a regulator controlling circuit coupled to the regulator and to the clock gate controlling circuit, where: the clock gate controlling circuit is configured to transmit a control signal to the clock gate; and the clock gate controlling circuit is coupled to a first input of the regulator, where the clock gate controlling circuit is configured to apply a voltage to the first input of the regulator to change the current based on the control signal.

Example 43. The circuit of example 42, where the first supply terminal is coupled to a battery power source; and where the regulator further includes: a second transistor coupled to the first transistor and to the second supply terminal, where the first input is coupled to a third transistor in series with the second transistor.

Example 44. The circuit of one of examples 42 or 43, where the first supply terminal is coupled to a battery power source; and where the regulator further includes: a second transistor coupled to first pass transistor and the second supply terminal, where the first input is coupled to a control terminal of the second transistor.

Example 45. The circuit of one of examples 42 to 44, further including: a clock requesting circuit coupled to the clock gate controlling circuit, where the clock requesting circuit is configured to generate a clock request signal to the clock gate controlling circuit.

Example 46. The circuit of one of examples 42 to 45, where the clock gate controlling circuit is configured to generate the control signal in response to the clock request signal.

Example 52. The circuit of one of examples 42 to 51, where the regulator includes a low dropout (LDO) voltage regulator.

Example 53. The circuit of one of examples 42 to 52, where the clock gate includes a first clock gate and the control signal includes a first control signal, and where the circuit further includes a second clock gate, where the second clock gate is coupled to the clock gate controlling circuit, further where the clock gate controlling circuit is configured to transmit a second control signal to the second clock gate and is further configured to change the current based on the second control signal.

Example 54. The circuit of one of examples 42 to 53, where the clock gate controlling circuit includes an OR gate having a first input configured to receive the first control signal and a second input configured to receive the second control signal, and an output coupled to the regulator controlling circuit.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A circuit comprising:
a clock gate controlling circuit;
a first clock gate coupled to the clock gate controlling circuit;
a regulator; and
a regulator controlling circuit coupled to the regulator and to the clock gate controlling circuit, wherein the clock gate controlling circuit is configured to transmit a control signal to the first clock gate and to cause the regulator controlling circuit to change a bandwidth of the regulator in response to the control signal.

2. The circuit of claim 1, wherein the regulator comprises a low dropout (LDO) voltage regulator having a pass transistor, wherein the regulator controlling circuit is configured to increase the bandwidth by increasing a current through the pass transistor.

3. The circuit of claim 1, further comprising:
an oscillator coupled to the first clock gate, wherein the first clock gate is configured to pass a first clock signal from the oscillator in response to the control signal.

4. The circuit of claim 3, wherein the first clock gate is configured to be powered by a first power domain, and wherein the oscillator is configured to be powered by a second power domain.

5. The circuit of claim 4, wherein the first power domain comprises a battery-powered power domain configured to be powered via the regulator, and wherein the second power domain comprises a supply powered power domain.

6. The circuit of claim 1, further comprising:
a capacitor coupled to the regulator, wherein the regulator is configured to drain charge from the capacitor in response to the bandwidth of the regulator being increased.

7. The circuit of claim 1, wherein the regulator comprises a low dropout (LDO) voltage regulator having a bias transistor, wherein the regulator control hardware logic is configured to increase the bandwidth by increasing a current through the bias transistor.

8. The circuit of claim 7, wherein the regulator controlling circuit is configured to increase the current through the bias transistor by adjusting a voltage applied to a control terminal of the bias transistor.

9. The circuit of claim 7, wherein the regulator controlling circuit is configured to increase the current through the bias transistor by turning on a switch in series with the bias transistor.

10. The circuit of claim 1, wherein the regulator controlling circuit is further configured to revert the bandwidth of the regulator to a prior setting in response to a state of the first control signal.

11. The circuit of claim 1, wherein the regulator is configured to power the clock gate controlling circuit and the first clock gate.

12. The circuit of claim 1, wherein the circuit comprises a meter having a real-time clock (RTC) subsystem, wherein the first clock gate is implemented within the RTC subsystem.

13. The circuit of claim 1, wherein the circuit comprises a meter having a memory, wherein the first clock gate is implemented within the memory subsystem.

14. The circuit of claim 1, wherein the regulator is coupled to a coin cell battery and is configured to output power to the first clock gate.

15. The circuit of claim 1, further comprising:
a second clock gate coupled to the clock gate controlling circuit, wherein the clock gate controlling circuit is configured to transmit a second control signal to the second clock gate and to cause the regulator controlling circuit to change the bandwidth of the regulator in response to the second control signal.

16. A circuit comprising:
a clock gate controlling circuit;
a clock gate coupled to the clock gate controlling circuit;
a regulator coupled to a first supply and a second supply, the regulator including a first transistor configured to carry current on a path between the first supply terminal and the second supply terminal; and
a regulator controlling circuit coupled to the regulator and to the clock gate controlling circuit, wherein:
the clock gate controlling circuit is configured to transmit a control signal to the clock gate; and
the clock gate controlling circuit is coupled to a first input of the regulator, wherein the clock gate controlling circuit is configured to apply a voltage to the first input of the regulator to change the current based on the control signal.

17. The circuit of claim 16, wherein the first supply terminal is coupled to a battery power source; and wherein the regulator further comprises:
a second transistor coupled to the first transistor and to the second supply terminal, wherein the first input is coupled to a third transistor in series with the second transistor.

18. The circuit of claim 16, wherein the first supply terminal is coupled to a battery power source; and wherein the regulator further comprises:
a second transistor coupled to first pass transistor and the second supply terminal, wherein the first input is coupled to a control terminal of the second transistor.

19. The circuit of claim 16, further comprising:
a clock requesting circuit coupled to the clock gate controlling circuit, wherein the clock requesting circuit is configured to generate a clock request signal to the clock gate controlling circuit.

20. The circuit of claim 19, wherein the clock gate controlling circuit is configured to generate the control signal in response to the clock request signal.

21. The circuit of claim 16, further comprising:
a controller circuit coupled to the clock gate controlling circuit; and
a memory coupled to the controller circuit and to the clock gate, wherein the controller circuit is configured to transmit a clock request signal to the clock gate controlling circuit, and wherein the clock gate controlling circuit is configured to generate the control signal in response to the clock request signal to cause a clock to be provided to the memory via the clock gate.

22. The circuit of claim 21, wherein the clock gate and the memory are configured to be powered by the regulator, and wherein the controller circuit is configured to be powered by a power supply separate from the regulator.

23. The circuit of claim 22, wherein the regulator is configured to be powered in a battery-powered domain, and wherein the controller circuit is configured to be powered in another power domain.

24. The circuit of claim 16, further comprising:
a controller circuit coupled to the clock gate controlling circuit, wherein the controller circuit is configured to transmit a clock request signal to the clock gate controlling circuit, and wherein the clock gate controlling circuit is configured to generate the control signal in response to the clock request signal.

25. The circuit of claim 24, wherein the clock gate is disposed within a real-time clock (RTC) system, wherein the regulator comprises a power output coupled to a power input of the RTC system.

26. The circuit of claim 16, wherein the regulator comprises a low dropout (LDO) voltage regulator.

27. The circuit of claim 16, wherein the clock gate comprises a first clock gate and the control signal comprises a first control signal, and wherein the circuit further comprises a second clock gate, wherein the second clock gate is coupled to the clock gate controlling circuit, further wherein the clock gate controlling circuit is configured to transmit a second control signal to the second clock gate and is further configured to change the current based on the second control signal.

28. The circuit of claim 27, wherein the clock gate controlling circuit comprises an OR gate having a first input configured to receive the first control signal and a second input configured to receive the second control signal, and an output coupled to the regulator controlling circuit.
